(19) United States
(12) Patent Application Publication
(10) Pub. No.: US 2026/0220267 A1
(43) Pub. Date: Jul. 30, 2026

(54) A SYSTEM AND METHOD FOR MALWARE DETECTION

(71) Applicant: CyTwist LTD., Ramat Gan (IL)

(72) Inventors: Yehonadav HERTZ, Ramat Gan (IL); Yosef KORAKIN, Ramat Gan (IL); Moshe FURMAN, Ramat Gan (IL); Oren BAHAR, Ramat Gan (IL)

(21) Appl. No.: 19/147,699

(22) PCT Filed: Jan. 9, 2024
(86) PCT No.: PCT/IL2024/050031

§ 371 Date: Jul. 13, 2025

Related U.S. Application Data
(60) Provisional application No. 63/480,516, filed on Jan. 19, 2023.

(51) Int. Cl. G06F 21/56

(52) U.S. Cl. CPC G06F 21/566; G06F 2221/034

(57) ABSTRACT

The presently disclosed subject matter aims for a malware detection system and method capable of detecting normally behaving malware. The system obtains one or more malware attack scenarios, each of which includes a series of one or more DLLs loading and of function calls executions. The loading of at least some of the DLLs and the execution of at least some of the series of function calls by a process serve as an indication that the process is malware.

### TECHNICAL FIELD

The present invention relates to the field of systems and methods for malware detection.

### BACKGROUND

The term “malware”, which is short for malicious software, is used to refer to any software designed to infiltrate or damage a computer system without the owner's informed consent. Malware can include viruses, worms, trojan horses, rootkits, adware, spyware, and any other malicious and unwanted software. Many computer devices, such as desktop personal computers (PCs), laptops, personal data assistants (PDAs), and mobile phones, can be at risk from malware.

Computer users will typically run antivirus (AV) and/or internet security (IS) software applications, for example, F-Secure's™ Internet Security applications, to detect malware and protect against malware attacks on their computer system. Detecting malware is challenging, as malware is usually designed to be difficult to detect, often employing technologies that deliberately hide the presence and processes of malware on a system. Consequently, anti-virus and internet security applications will use a large number of techniques in order to detect malware most effectively and reduce the risk of any malware going undetected.

Nowadays, most malware detection techniques focus on signatures of files suspected as malware and on runtime anomalies of processes that behave outside the norm of a regular operation. This approach results in an inability of said techniques to determine that a process which acts normally is actually malware.

Thus, there is a need in the art for a new system and method for malware detection.

### GENERAL DESCRIPTION

In accordance with a first aspect of the presently disclosed subject matter, there is provided a malware detection system comprising a processing circuitry configured to: obtain: (a) one or more malware scenarios, wherein each malware scenario is associated with a process including a series of one or more of: (i) one or more first DLL loadings, or (ii) one or more first function call executions, and (b) one or more actual processes, each of which is executed on a respective processor of a plurality of processors, wherein each actual process includes a series of one or more of: (iii) one or more second DLL loadings, or (iv) one or more second function call executions; identify at least one actual process of the one or more actual processes as a potential malware process by matching at least some of the one or more first DLL loadings or the one or more first function call executions of said at least one actual process with at least some of the one or more second DLL loadings or the one or more second function call executions of at least one process associated with at least one malware scenario of the malware scenarios; and based on said identification, alert a user of the malware detection system of a potential malware associated with said at least one actual process.

In some cases, upon identifying the at least one actual process as a potential malware process, the system accesses the processor associated with the potential malware process and identifies an actual malware.

In some cases, the identification of the actual malware is performed by matching one or more of the remaining first DLL loadings or the remaining first function call executions of said potential malware process with one or more of the remaining second DLL loadings or the remaining second function call executions of the at least one process associated with said at least one malware scenario.

In some cases, the actual malware is identified by filtering the potential malware based on one or more of: signatures, timestamps, or any combination thereof.

In accordance with a first aspect of the presently disclosed subject matter, there is provided a malware detection method comprising: obtaining: (a) one or more malware scenarios, wherein each malware scenario is associated with a process including a series of one or more of: (i) one or more first DLL loadings, or (ii) one or more first function call executions, and (b) one or more actual processes, each of which is executed on a respective processor of a plurality of processors, wherein each actual process includes a series of one or more of: (iii) one or more second DLL loadings, or (iv) one or more second function call executions; identifying at least one actual process of the one or more actual processes as a potential malware process by matching at least some of the one or more first DLL loadings or the one or more first function call executions of said at least one actual process with at least some of the one or more second DLL loadings or the one or more second function call executions of at least one process associated with at least one malware scenario of the malware scenarios; and based on said identification, alerting a user of the malware detection system of a potential malware associated with said at least one actual process.

In some cases, upon identifying the at least one actual process as a potential malware process, the system accesses the processor associated with the potential malware process and identifies an actual malware.

In some cases, the identification of the actual malware is performed by matching one or more of the remaining first DLL loadings or the remaining first function call executions of said potential malware process with one or more of the remaining second DLL loadings or the remaining second function call executions of the at least one process associated with said at least one malware scenario.

In some cases, the actual malware is identified by filtering the potential malware based on one or more of: signatures, timestamps, or any combination thereof.

In accordance with a first aspect of the presently disclosed subject matter, there is provided a non-transitory computer readable storage medium having computer readable program code embodied therewith, the computer readable program code, executable by at least one processor to perform a malware detection method, the method comprising: obtaining: (a) one or more malware scenarios, wherein each malware scenario is associated with a process including a series of one or more of: (i) one or more first DLL loadings, or (ii) one or more first function call executions, and (b) one or more actual processes, each of which is executed on a respective processor of a plurality of processors, wherein each actual process includes a series of one or more of: (iii) one or more second DLL loadings, or (iv) one or more second function call executions; identifying at least one actual process of the one or more actual processes as a potential malware process by matching at least some of the one or more first DLL loadings or the one or more first function call executions of said at least one actual process with at least some of the one or more second DLL loadings or the one or more second function call executions of at least one process associated with at least one malware scenario of the malware scenarios; and based on said identification, alerting a user of the malware detection system of a potential malware associated with said at least one actual process.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an environment on which a system for malware detection operates, in accordance with the presently disclosed subject matter;

FIG. 2 is a block diagram schematically illustrating one example of a system for malware detection, in accordance with the presently disclosed subject matter;

FIG. 3 is a flowchart illustrating an example of a sequence of operations carried out by a system for malware detection, in accordance with the presently disclosed subject matter; and,

FIG. 4 is a table of a non-limiting example accompanying the sequence of operations carried out by the system for malware detection of FIG. 3, in accordance with the presently disclosed subject matter;

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “identifying”, “alerting”, “accessing”, or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

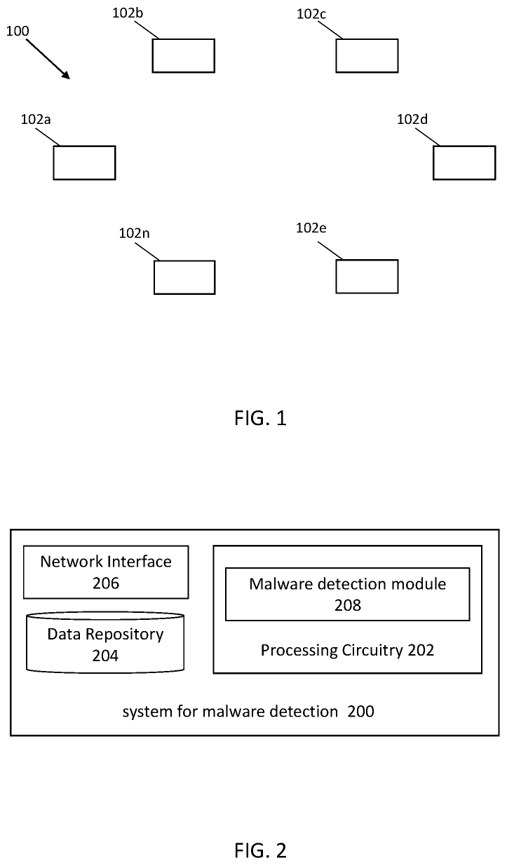

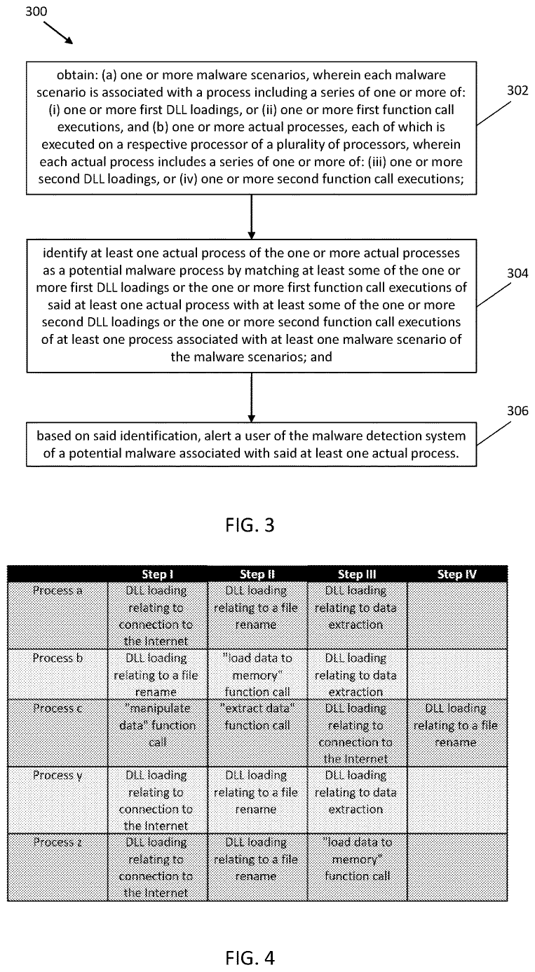

In embodiments of the presently disclosed subject matter, fewer, more and/or different stages than those shown in FIG. 3 may be executed. In embodiments of the presently disclosed subject matter one or more stages illustrated in FIG. 3 may be executed in a different order and/or one or more groups of stages may be executed simultaneously. FIGS. 1 and 2 illustrate a general schematic of the system architecture in accordance with an embodiment of the presently disclosed subject matter. Each module in FIG. 2 can be made up of any combination of software, hardware and/or firmware that performs the functions as defined and explained herein. The modules in FIG. 2 may be centralized in one location or dispersed over more than one location. In other embodiments of the presently disclosed subject matter, the system may comprise fewer, more, and/or different modules than those shown in FIG. 3.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, showing a schematic illustration of an environment on which a system for malware detection (also interchangeably referred to herein as “system”) operates, in accordance with the presently disclosed subject matter.

As shown in the schematic illustration, environment 100 includes one or more processors, denoted 102a to 102n. Each of processors 102a to 102n may be one of: a microprocessor, a multi-core processor, an embedded processor, a digital signal processor, a central processing unit (CPU), a microcontroller, or any other suitable processing unit, and may operate dependently or independently of other processors (i.e., be linked or non-linked to the other processors). In addition, each of processors 102a to 102n may be part of a computing device (not shown), such as a desktop personal computer (PC), a laptop computer, a tablet computer, a personal data assistant (PDA), a mobile phone, or any other suitable device. The computing devices may function independently or be part of a computing network in which each computing device interacts with other computing devices.

During the operation of each given processor of processors 102a to 102n (i.e., during runtime), the given processor may be configured to execute one or more processes (typically associated with one or more respective files or data sets) composed of a series of steps. Each step may be related to an action directed to be performed by the given processor. In one non-limiting example, the action may involve one or more Dynamic-Link Library (DLL) loadings, e.g., DLL loading relating to connection to the Internet, DLL loading relating to a file rename, DLL loading relating to data extraction, etc. In another non-limiting example, alternatively or additionally to the latter, the action may involve one or more function call executions, e.g., “load data to memory” function call, “manipulate data” function call, “extract data” function call, and the like.

Within the series of steps, actions considered as “innocent”, i.e., actions not intended in any way, shape, or form to infiltrate or damage the given processor executing said one or more processes, may turn out to be “malicious”, i.e., actions that are part of a potential malware attack scenario intended to cause the given processor to operate without the user's informed consent. Such occurrences are feasible given the ability of malware to intentionally exploit the “innocent” appearance of said “innocent” actions so as to hide its presence and related processes on the given processor. For example, the “load data to memory” function call may be an “innocent” function call as part of an intentional process initiated by a user. Alternatively, said “load data to memory” function call may be a “malicious” function call as part of a malware attack scenario initiated without the user's informed consent. In a similar manner, a DLL loading relating to connection to the Internet may be an “innocent” DLL loading as part of an intentional process initiated by the user or a “malicious” DLL loading as part of a malware attack scenario initiated without the user's informed consent.

To differentiate whether a process performed by a given processor, including one or more “innocent” actions, is an intentional process initiated by the user or a potential malware attack scenario, as described hereinbefore, the system for malware detection performs a malware detection process, as will be explained in detail below in relation to FIG. 3.

Attention is now drawn to a description of the components of the system for malware detection 200.

FIG. 2 is a block diagram schematically illustrating one example of the system for malware detection 200, in accordance with the presently disclosed subject matter.

In accordance with the presently disclosed subject matter, the system for malware detection 200 (also interchangeably referred to herein as “system 200”) can comprise a network interface 206. The network interface 206 (e.g., a network card, a Wi-Fi client, a Li-Fi client, 3G/4G client, or any other component), enables system 200 to communicate over a network with external systems and handles inbound and outbound communications from such systems. For example, system 200 can obtain, through network interface 206, one or more malware scenarios.

System 200 can further comprise or be otherwise associated with a data dictionary 204 (e.g., a database, a storage system, a memory including Read Only Memory—ROM, Random Access Memory—RAM, or any other type of memory, etc.) configured to store data. Some examples of data that can be stored in the data dictionary 204 include:
One or more malware scenarios;
One or more first DLL loadings;
One or more second DLL loadings;
One or more first function calls executions;
One or more second function calls executions;
One or more actual processes;
One or more potential malware processes; etc.

Data repository 204 can be further configured to enable retrieval and/or update and/or deletion of the stored data. It is to be noted that in some cases, data repository 204 can be distributed, while the system 200 has access to the information stored thereon, e.g., via a wired or wireless network to which system 200 is able to connect (utilizing its network interface 206).

System 200 further comprises processing circuitry 202. Processing circuitry 202 can be one or more processing units (e.g., central processing units), microprocessors, microcontrollers (e.g., microcontroller units (MCUs)) or any other computing devices or modules, including multiple and/or parallel and/or distributed processing units, which are adapted to independently or cooperatively process data for controlling relevant system 200 resources and for enabling operations related to system's 200 resources.

The processing circuitry 202 comprises a malware detection module 208, configured to perform a malware detection process, as further detailed herein, inter alia with reference to FIG. 3.

Turning to FIG. 3 there is shown a flowchart illustrating one example of operations carried out by the system for malware detection 200, in accordance with the presently disclosed subject matter.

Accordingly, the system for malware detection 200 (also interchangeably referred to hereafter as “system 200”) can be configured to perform a malware detection process 300, e.g., using malware detection module 208.

For this purpose, system 200 obtains (a) one or more malware scenarios, and (b) one or more actual processes.

Each of said one or more malware scenarios is associated with a process including a series of one or more of: (i) one or more first DLL loadings, or (ii) one or more first function call executions, whereas each of said one or more actual processes, executed on a respective processor of a plurality of processors, includes a series of one or more of (iii) one or more second DLL loadings, or (iv) one or more second function call executions (block 302).

By way of a non-limiting example, presented for purposes of better understanding the presently disclosed subject matter and in no way intended to limit the scope of the presently disclosed subject matter, as illustrated in FIG. 4, system 200 obtains three malware scenarios, denoted “A”, “B”, and “C”, and two actual processes, denoted “y” and “z”, each of which is executed on a respective processor of a respective PC.

The three malware scenarios, A”, “B”, and “C”, are each associated with a respective process denoted, “a”, “b”, and “c”, such that process “a” consists of a series of three steps of first DLL loadings (DLL loading relating to connection to the Internet, DLL loading relating to a file rename, DLL loading relating to data extraction), process “b” consists of a series of three steps of two subsequent first DLL loadings separated by a first function call execution (DLL loading relating to a file rename, “load data to memory” function call, DLL loading relating to data extraction), and process “c” consists of a series of four steps of two subsequent first function call executions followed by two subsequent first DLL loadings (“manipulate data” function call, “extract data” function call, DLL loading relating to connection to the Internet, DLL loading relating to a file rename). In contrast, actual processes “y” and “z” are each composed of a series of three steps, such that process “y” consists of three subsequent second DLL loadings (DLL loading relating to connection to the Internet, DLL loading relating to a file rename, DLL loading relating to data extraction), whereas process “z” consists of two subsequent second DLL loading followed by a second function call execution (DLL loading relating to connection to the Internet, DLL loading relating to a file rename, “load data to memory” function call).

Upon obtaining of the malware scenarios and the actual scenarios, system 200 identifies at least one actual process of the actual processes as a potential malware process by matching at least some of its first DLL loadings or its first function call executions with at least some of the second DLL loadings or the second function call executions of at least one process associated with at least one malware scenario of the malware scenarios (block 304).

In accordance with our non-limiting example, both processes “y” and “z” are considered potential malware processes since the first two steps of their respective series of steps are identical to the first two steps of process “a”.

Upon identification, system 200 alerts a user of the malware detection system of a potential malware associated with the at least one actual process (block 306).

In accordance with our non-limiting example, system 200 alerts the user of the malware detection system that processes “y” and “z” are potential malware.

In some cases, alternatively or additionally to the above, system 200 may access the processor associated with the potential malware process and identify an actual malware. In such cases, the identification of the actual malware may be performed, for example, by matching one or more of the remaining first DLL loadings or the remaining first function call executions of said potential malware process with one or more of the remaining second DLL loadings or the remaining second function call executions of the at least one process associated with said at least one malware scenario.

In accordance with our non-limiting example, by matching the remaining step of process “y” (DLL loading relating to data extraction) and the remaining step of process “z” (“load data to memory” function call) with the remaining step of process “a” (DLL loading relating to data extraction), system 200 identifies process “y” as an actual malware, as its remaining step matches the remaining step of process “a” (DLL loading relating to data extraction=DLL loading relating to data extraction). Similarly, system 200 identifies process “z” as a non-actual malware, as its remaining step does not match the remaining step of process “a” (DLL loading relating to data extraction #“load data to memory” function call).

In other cases, alternatively or additionally to the latter, the actual malware may be identified by filtering the potential malware based on one or more of: signatures, timestamps, or any combination thereof.

It is to be noted, with reference to FIG. 3, that some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A malware detection system comprising a processing circuitry configured to:
obtain: (a) one or more malware scenarios, wherein each malware scenario is associated with a process including a series of one or more of: (i) one or more first DLL loadings, or (ii) one or more first function call executions, and (b) one or more actual processes, each of which is executed on a respective processor of a plurality of processors, wherein each actual process includes a series of one or more of: (iii) one or more second DLL loadings, or (iv) one or more second function call executions;
identify at least one actual process of the one or more actual processes as a potential malware process by matching at least some of the one or more first DLL loadings or the one or more first function call executions of said at least one actual process with at least some of the one or more second DLL loadings or the one or more second function call executions of at least one process associated with at least one malware scenario of the malware scenarios; and
based on said identification, alert a user of the malware detection system of a potential malware associated with said at least one actual process.

2. The malware detection system of claim 1, wherein upon identifying the at least one actual process as a potential malware process, the system accesses the processor associated with the potential malware process and identifies an actual malware.

3. The malware detection system of claim 2, wherein the identification of the actual malware is performed by matching one or more of the remaining first DLL loadings or the remaining first function call executions of said potential malware process with one or more of the remaining second DLL loadings or the remaining second function call executions of the at least one process associated with said at least one malware scenario.

4. The malware detection system of claim 2, wherein the actual malware is identified by filtering the potential malware based on one or more of: signatures, timestamps, or any combination thereof.

5. A malware detection method comprising:
obtaining: (a) one or more malware scenarios, wherein each malware scenario is associated with a process including a series of one or more of: (i) one or more first DLL loadings, or (ii) one or more first function call executions, and (b) one or more actual processes, each of which is executed on a respective processor of a plurality of processors, wherein each actual process includes a series of one or more of: (iii) one or more second DLL loadings, or (iv) one or more second function call executions;
identifying at least one actual process of the one or more actual processes as a potential malware process by matching at least some of the one or more first DLL loadings or the one or more first function call executions of said at least one actual process with at least some of the one or more second DLL loadings or the one or more second function call executions of at least one process associated with at least one malware scenario of the malware scenarios; and
based on said identification, alerting a user of the malware detection system of a potential malware associated with said at least one actual process.

6. The malware detection method of claim 5, wherein upon identifying the at least one actual process as a potential malware process, the system accesses the processor associated with the potential malware process and identifies an actual malware.

7. The malware detection method of claim 6, wherein the identification of the actual malware is performed by matching one or more of the remaining first DLL loadings or the remaining first function call executions of said potential malware process with one or more of the remaining second DLL loadings or the remaining second function call executions of the at least one process associated with said at least one malware scenario.

8. The malware detection method of claim 6, wherein the actual malware is identified by filtering the potential malware based on one or more of: signatures, timestamps, or any combination thereof.

9. A non-transitory computer readable storage medium having computer readable program code embodied therewith, the computer readable program code, executable by at least one processor to perform a malware detection method, the method comprising:
obtaining: (a) one or more malware scenarios, wherein each malware scenario is associated with a process including a series of one or more of: (i) one or more first DLL loadings, or (ii) one or more first function call executions, and (b) one or more actual processes, each of which is executed on a respective processor of a plurality of processors, wherein each actual process includes a series of one or more of: (iii) one or more second DLL loadings, or (iv) one or more second function call executions;
identifying at least one actual process of the one or more actual processes as a potential malware process by matching at least some of the one or more first DLL loadings or the one or more first function call executions of said at least one actual process with at least some of the one or more second DLL loadings or the one or more second function call executions of at least one process associated with at least one malware scenario of the malware scenarios; and
based on said identification, alerting a user of the malware detection system of a potential malware associated with said at least one actual process.
